(19) United States
(12) Patent Application Publication
(10) Pub. No.: US 2021/0394981 A1
(43) Pub. Date: Dec. 23, 2021

(54) LOCKING MUG

(71) Applicant: Madison Warner, Warrensville, NC (US)

(72) Inventors: Madison Warner, Warrensville, NC (US); Jason McGrath, Broomfield, CO (US); Nicholas Anderson, Boulder, CO (US); Samuel House, Boulder, CO (US)

(21) Appl. No.: 16/908,860

(22) Filed: Jun. 23, 2020

(51) Int. Cl. B65D 55/14; B65D 51/24; A47G 19/22; H01R 13/447; G07C 9/37; G06K 9/00

(52) U.S. Cl. CPC B65D 55/14; B65D 51/24; G06K 9/00013; H01R 13/447; G07C 9/37; A47G 19/2205

(57) ABSTRACT

A locking mug is implemented which is configured with a locking mechanism by which the lid is locked to a cup until an authorized user unlocks the locking mug using their fingerprint. The locking mug may come equipped with the necessary hardware and software to store a fingerprint profile associated with a unique user and then use that fingerprint profile to verify that an authorized user is accessing the locking mug's contents. The locking mug includes a fingerprint scanner that scans the user's fingerprint each time the user wishes to unlock the locking mug and drink its contents. The security measures provided by the locking mug prevents unsuspecting users from being harmed by external predators. The configuration and design of the lid's locking features and security software for verifying a unique user's fingerprint profile facilitates user safety when using the portable locking mug.

### BACKGROUND

People of all ages and genders are used to carrying around drinks such as coffee, water, or an alcoholic beverage. These drinks may be carried in a glass or portable mug which are invariably subject to tampering. For example, it is possible that a cup can be spiked with some form of a drug, like Rohypnol® or other date rape drugs, which could make the victim vulnerable to attack or other predatory behavior.

### SUMMARY

A locking mug is implemented which is configured with a locking mechanism by which the lid is locked to the cup unless and until an authorized user unlocks the locking mug with their fingerprint. The locking mug may come equipped with the necessary hardware and software to store a fingerprint profile associated with a unique user and then use that fingerprint profile to verify that an authorized user is accessing the locking mug's contents. The locking mug includes a fingerprint scanner that scans the user's fingerprint each time the user wishes to unlock the locking mug and drink its contents. Other authentication credentials in addition to or separate from a fingerprint are also possible for controlling user access, such as a pin code, pattern, facial recognition, etc. The locking mug may utilize two different finger positions in which one finger position can either unlock the opening on the lid to release liquid, and another finger position can cause the lid to unlock and disengage from the cup.

The locking mug may include an input interface, such as mechanical buttons or a touchscreen display, or other input mechanism on a bottom surface of the lid to enable the user to configure the lid for the user's fingerprint profile. For example, the user may input some pre-set code specific to that locking mug which enables device configuration, namely for the user to scan their fingerprint to initiate the storage of the fingerprint profile. The input interface may be configured with a water-resistant membrane switches so the interface can function after coming in contact with the various liquids stored inside the cup. The outer portion of the lid may also include an indicator light which identifies to the user whether the lid is locked or unlocked.

Advantageously, the security measures provided by the locking mug prevent unsuspecting users from being harmed by external predators. The configuration and design of the lid's input mechanisms, locking features, and security software for verifying a unique user fingerprint profile, along with the lid's interoperability with the cup, facilitates user safety when using the portable locking mug. The combination of these features also enables greater user control over the locking mug's accessibility, and thereby provides users with greater comfort when drinking from their mug.

### DESCRIPTION OF THE DRAWINGS

FIG. 1 shows an illustrative representation of a locking mug;

FIG. 2 shows an illustrative layered architecture of the locking mug;

FIG. 3 shows an illustrative representation in which a lid of the locking mug unlocks and lifts from a cup for the first use;

FIG. 4 shows an illustrative representation of the resistant surface and touchscreen display on a bottom surface of the locking mug's lid;

FIG. 5 shows an illustrative representation of a user's fingerprint profile being set using the fingerprint scanner;

FIG. 6 shows an illustrative representation of the locking mug's fingerprint scanner being subsequently used;

FIGS. 7A and 7B show an illustrative diagrams of the locking mug's locking mechanism components for the lid;

FIG. 8 shows an illustrative flowchart which may be performed by the locking mug; and

FIG. 9 shows an illustrative computer system which may be used with the locking mug.

### DETAILED DESCRIPTION

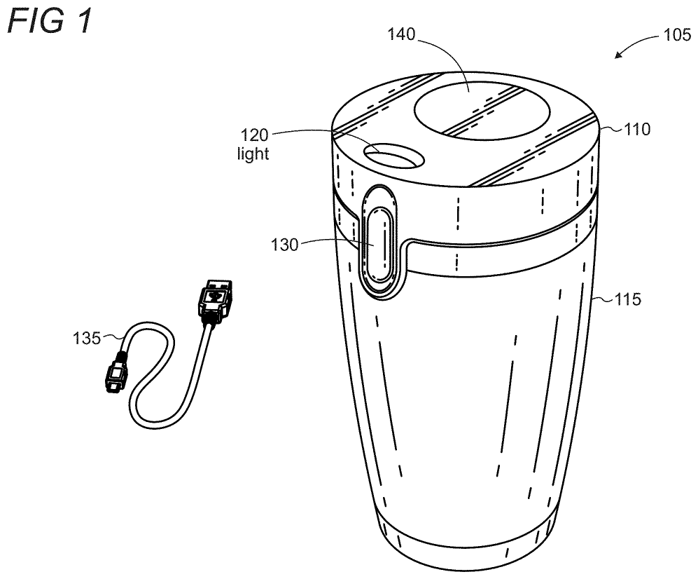

FIG. 1 shows an illustrative representation in which a locking mug 105 includes a cup 115 and lid 110 which secures to the cup. The locking mug includes an indicator light 120 that can inform a user whether the locking mug is in a locked or unlocked state. For example, a green light may indicate that the locking mug has been unlocked and an empty light can indicate that the locking mug is locked and the lid cannot be disengaged from the cup. In typical implementations, the lid and cup may be threaded about each other so that a twisting motion can cause the lid to engage and disengage from the cup. As discussed in greater detail below, the lid of the locking mug includes a fingerprint scanner 130 which can be used to provide access to the contents of the locking mug to an authorized user. For example, the barrier 140, which is in a locked position, can unlock and lead to an opening to enable the fluid inside the cup to flow out the lid. As various electronic circuitry and components are utilized in the locking mug, a wire having USB (uniform serial bus) connectors (e.g., USB-Micro B or USB-C style connectors) can be utilized with the locking mug for charging its battery.

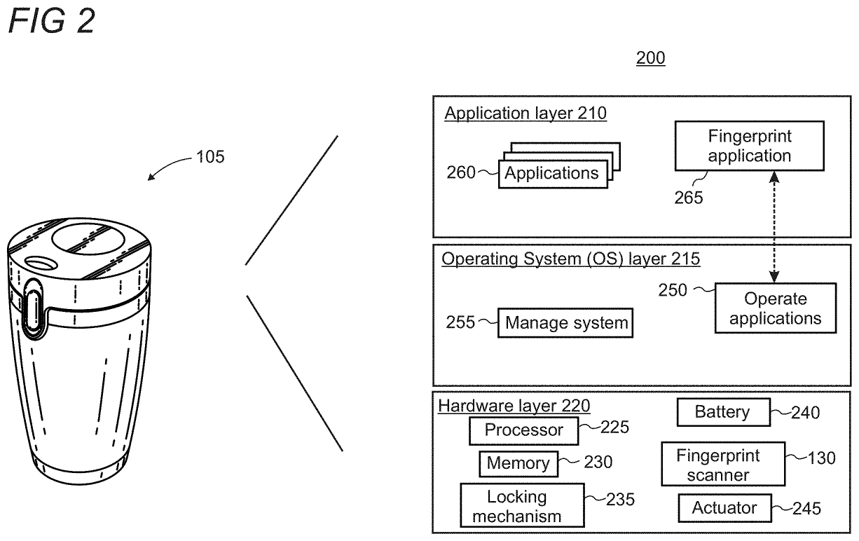

FIG. 2 shows an illustrative layered architecture 200 of the locking mug 105 to facilitate the functionality and features described herein. The exemplary and simplified architecture is arranged in layers and includes a hardware layer 220, an operating system (OS) layer 215, and an application layer 210. The hardware layer 220 provides an abstraction of the various hardware used by the locking mug 105 to the layers above it. In this illustrative example, the hardware layer supports one or more processors 225, memory 230, locking mechanism 235, a battery 240, such as a rechargeable lithium battery, a fingerprint scanner 130, and an actuator 245 to lock and unlock the locking mug responsive to user authorization.

In typical implementations, the one or more processors 225 may be a central processing unit (CPU) or a microcontroller configured to perform discrete operations. The memory 230 may include data and instructions which are executable by the one or more processors. The locking mechanism 235 may interoperate with and be controlled by the actuator 245 for locking and unlocking the locking mug 105. For example, a solenoid can move a rod linearly, typically in two positions. Servos can move either radially or linearly and are characterized by having a feedback mechanism for determining its position. The solenoid can be used to move a bolt or other connector to prevent rotation of the lid 110. Thus, the bolt can prevent the lid from rotating when extended and can release the lid for rotation about the cup when compressed. With respect to the barrier 140 on the lid, an actuator, solenoid, and servos may likewise control and move the barrier from an extended or retracted state, in which the extended state blocks the lid's opening and the retracted state unblocks the opening to enable release of the fluid from the cup.

The fingerprint scanner 130 may be comprised of a sensor to scan a user's fingerprint and store a fingerprint profile for a unique user and use that profile to provide the user with access to the mug upon receiving and authenticating fingerprints from subsequent scans. The fingerprint scanner may be an optical scanner which takes an image of the fingerprint or a capacitive sensor which uses electricity (similar to a touchscreen) to determine fingerprint patterns. The capacitive scanner may, for example, measure a charge of the user's finger as ridges exhibit a change in capacitance and valleys produce little to no change. An ultrasonic sensor can also be utilized which measures sound waves by sending out ultrasonic pulses and measuring the bounce back to assess ridges and valleys in a fingerprint to identify a fingerprint profile. The fingerprint scanner may, responsive to receiving an authorized fingerprint scan, cause the processor to trigger the actuator 245 to unlock the locking mechanism and thereby provide the authorized user with access to the locking mug's contents.

Although not shown in FIG. 2, the locking mug 105 may further include an input/output (I/O) device, such as membrane switches, in-mold labeling, or a touchscreen display, which can be used for initiating use and configuration of the locking mug.

The OS 215 supports, among other operations, managing the operating system 255 and operating applications 250, as illustratively shown by the arrow. The OS layer may interoperate with the application and hardware layers to facilitate execution of programs and perform various functions and features.

The application layer 210 can support various applications 260, including a fingerprint application 265. Any number of applications can be utilized by the locking mug 105, whether proprietary or third-party applications. In typical implementations, the applications may be implemented using locally executing code stored in memory 230.

The fingerprint application 265 may be configured to store fingerprint profiles for one or more unique users of the locking mug 105. These fingerprint profiles may be used as a frame of reference to compare subsequent scans of users' fingerprints to authorize or deny access to the locking mug's contents by, for example, opening the barrier 140 or enabling the lid to enter an unlocked state and disengage from the cup.

The fingerprint application 265 may receive a user's fingerprint scan taken from the fingerprint scanner 130 and compare the scanned fingerprint to any of the one or more fingerprint profiles stored in memory 230. If the scanned fingerprint corresponds in similarity beyond a pre-set threshold similarity level, then the fingerprint application may grant the user access by changing the indicator light 120 (FIG. 1) to, for example, green, and by triggering the actuator 245 to unlock the locking mechanism 235. Comparison of the fingerprints may be based on the shape and pattern of ridges and valleys in the user's fingerprint, such as by comparing a certain number of points between the profile and the scan.

While using a user's fingerprint is discussed herein, other authentication credentials in addition to or separate from a fingerprint are also possible for controlling user access, such as a pin code, pattern code, facial recognition, etc. For example, another input mechanism, such as a touchscreen display, may be positioned somewhere on the outside of the locking mug 105, such as on the lid 110 or cup 115. This touchscreen display may enable the user to enter a certain code to unlock the lid from the cup. Additionally or alternatively, a camera may be the input mechanism on the outside which compares the user's face to a facial profile previously stored in memory.

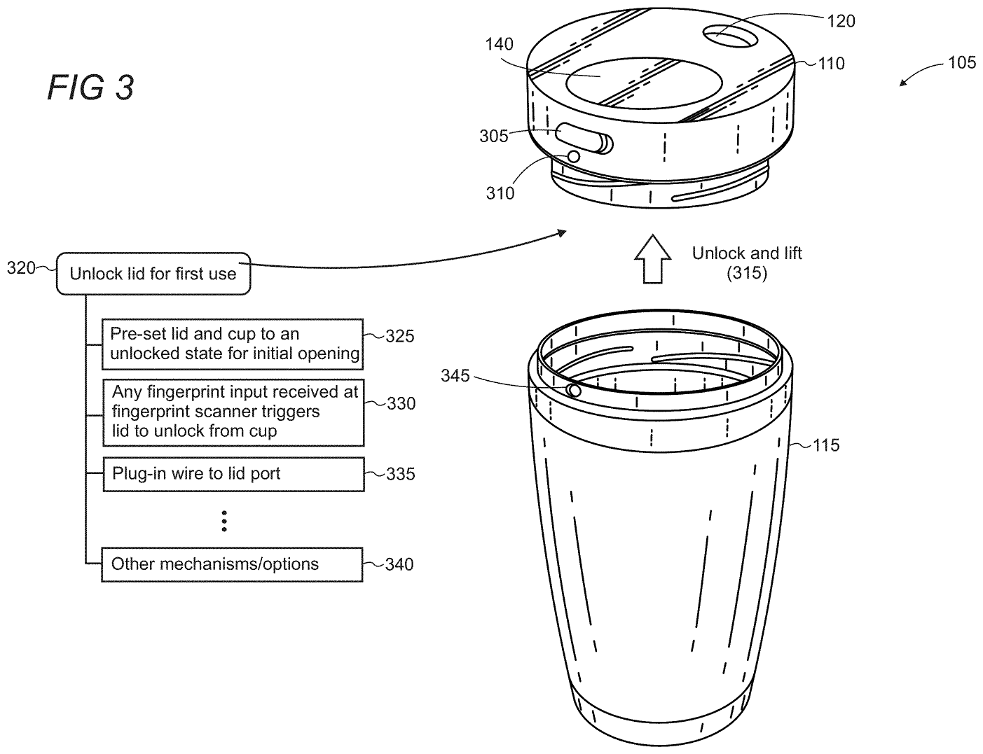

FIG. 3 shows an illustrative representation in which a schema of scenarios is disclosed for unlocking the locking mug 105 for the first use, as representatively shown by numeral 320. The non-exhaustive schema includes pre-setting the lid and cup to an unlocked state for the initial opening 325, any fingerprint input received at the fingerprint scanner triggers the lid to unlock from the cup 330, plugging the wire into the lid 335, and other mechanisms/options 340. In the implementation in which the lid is unlocked and detached from the cup, the user may set her own code for the first and subsequent uses. For example, the user may input a four (or other amount) digit pin code which causes the lid to set that code for all future calibrations. Upon entering the user's unique code, the user can add a fingerprint profile using the fingerprint scanner. This can occur for future uses as well, such as to allow the user to configure more than one fingerprint or to allow multiple users to use the same cup, such as family members.

Responsive to the locking mug 105 entering an unlocked state, the lid can unlock and lift from the cup, as representatively shown by numeral 315. FIG. 3 shows a receptacle 345 which may be used as part of the locking mechanism 235. The receptacle in the cup may be the portion which engages and disengages with a bolt (not shown) that extends and retracts in the lid 110, to thereby provide a locking and unlocking state. FIG. 3 also shown a cover 305 under which is a charging port for plugging in the wire 135 (FIG. 1) and an associated light 310 to indicate whether the lid is charging.

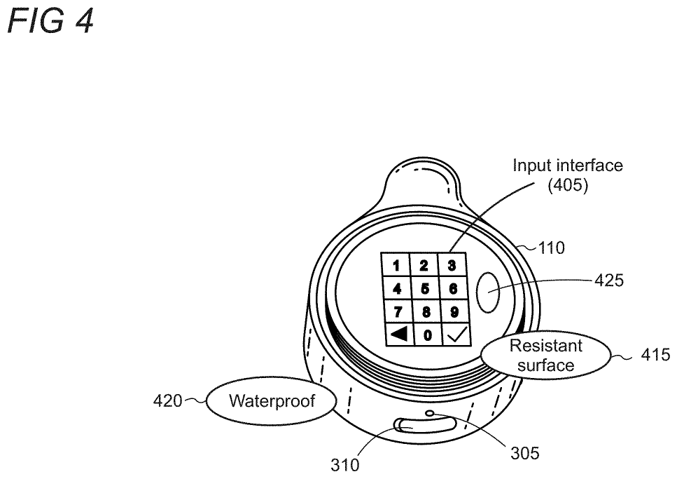

FIG. 4 shows an illustrative representation in which a bottom side surface of the lid 110 includes an input interface 405 for receiving user input. The input interface has a resistant surface membrane to withstand and maintain its functionality after being splashed with liquid contents inside the cup 115. The input interface may be created using an in-mold labeling which creates membrane switches. These membrane switches are mechanical buttons which are water resistant. In other implementations, a touchscreen display may also be utilized which may have a water-resistant surface as well. The lid is also sealed and waterproof to protect the various electrical components inside (FIG. 2). The opening 425 leads to a flow path within the lid through which liquid within the cup can flow out from the top of the lid when the barrier 140 unblocks the lid's opening.

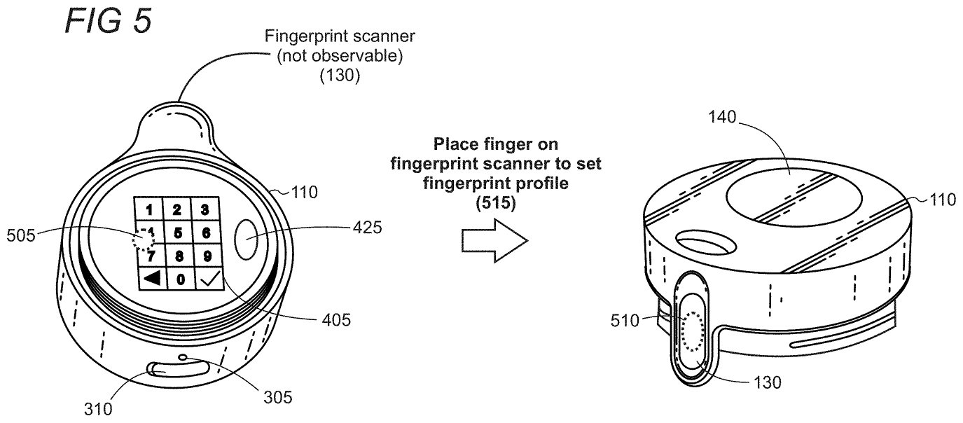

FIG. 5 shows an illustrative representation in which the input interface 405 is utilized by the user to configure the locking mug's features for use. For example, the user may input 505 some code to initiate a fingerprint scan to configure the user's fingerprint profile with the locking mug 105, as representatively illustrated by numeral 515. The code may be unique to that product and provided to the user via a sticker or label on the locking mug itself, the product packaging, etc. Alternatively, the code may be set based on the user's input code during the first use. Reset codes may also be utilized by the device, such as entering the number “0” (zero) four times, which can reset the code and enable the user to set a new code for configuring the device. Another reset code, such as entering the number “1” (one) four times, to erase all fingerprint profiles.

Responsive to the user entering a correct code on the input interface for device configuration, the user can place his or her finger, such as a thumb, on the fingerprint scanner 130, as representatively illustrated by numeral 510. The fingerprint scanner may pass the fingerprint to the processor 225 which will then store that fingerprint profile in memory 230. This fingerprint profile will be used for future reference to verify that an authorized user is opening the locking mug 105.

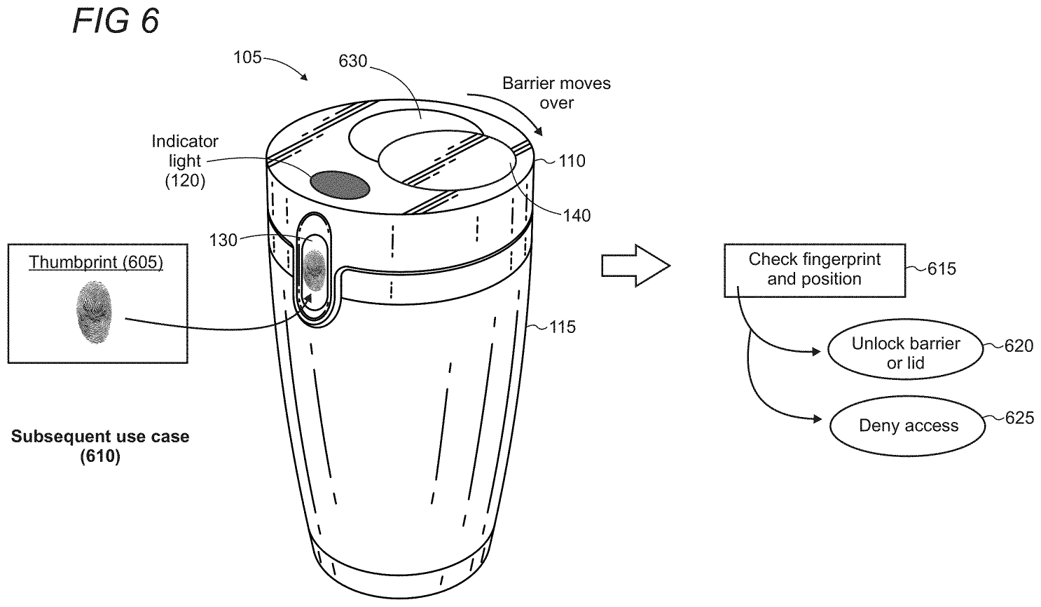

FIG. 6 shows an illustrative representation in which a subsequent use case 610 is depicted after the user's fingerprint profile has been set and stored (FIG. 5). The user may place his or her finger on the fingerprint scanner 605 which will result in a thumbprint (or other fingerprint) to be scanned. The locking mug, such as using the one or more processors 225, may check the received fingerprint 615 by comparing it to the fingerprint profile (or profiles) stored in memory 230. If the two fingerprints match or correspond beyond a pre-set threshold, then the locking mug can either unlock the barrier 140 or the lid from the cup depending on the finger's positioning over the scanner.

Exemplary fingerprint positions on the fingerprint scanner 130 that may affect whether the locking mug unlocks the barrier or the lid from the cup entirely includes whether the user's finger is placed on a top or bottom portion of the scanner, whether the user's finger is vertical, horizontal, or diagonal (or other directional orientation), among other positions. For example, the locking mug may associate a vertical finger position with unlocking the barrier, and the locking mug may associate a horizontal finger position with unlocking the lid from the cup.

Thus, upon authenticating the fingerprint, the locking mug may unlock the barrier or lid 620 and thereby provide the user access to the cup's contents. For example, the barrier 140 may automatically move or unlock to enable the user to move the barrier herself, thereby providing access to the opening 630. The opening may lead to a flow path which extends to the bottom side of the lid 110 and into the cup 115. If the two fingerprints fail to match or correspond beyond the pre-set threshold, then the locking mug may maintain its locked stated and deny user access 625 to the cup's contents. The indicator light 120 may turn a particular color, like red, when access is denied.

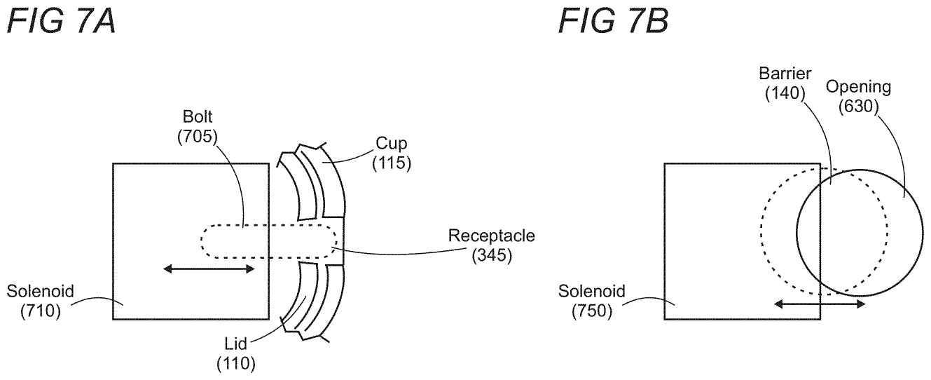

FIG. 7A shows an illustrative diagram in which the locking mechanism 235 provides a locked and unlocked state for the locking mug 105. A solenoid 710 employs a bolt 705 which extends and retracts about the arrow. In an extended position, the bolt engages with the receptacle 345 on the cup 115 to prevent the lid 110 from rotating. When the bolt retracts and disengages from the receptacle, then the user is able to rotate the lid about the corresponding threads on the cup and thereby open the locking mug.

The barrier 140 may operate similarly to the lid and cup mechanism shown in FIG. 7A. For example, FIG. 7B shows an illustrative diagram in which the barrier 140 provides a locked and unlocked state for the opening 630 in the lid 110. In an extended position, the barrier blocks the opening and thereby prevents any liquid from escaping. In the retracted state, which occurs when the user's fingerprint is authenticated, the barrier unblocks the opening and thereby enables fluid to flow from the cup 115. As discussed previously, whether the lid detaches from the cup (FIG. 7A) or the barrier unblocks the opening (FIG. 7B), depends on the one or more of the orientation or positioning of the user's finger on the fingerprint scanner 130.

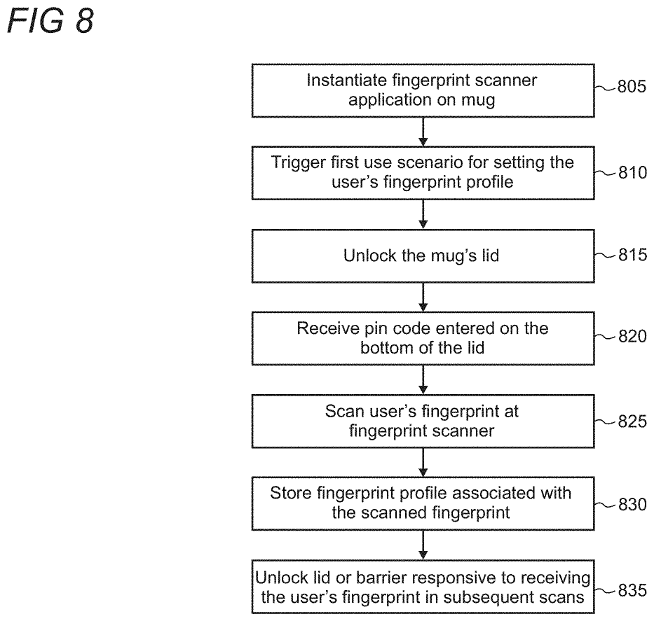

FIG. 8 shows an illustrative process in which the present locking mug 105 may implement. In step 805, the locking mug may instantiate a fingerprint scanner application. In step 810, the locking mug may trigger a first use scenario for setting the user's fingerprint profile. In step 815, the locking mug unlocks the lid. In step 820, the locking mug receives a pin code that is entered on the touchscreen display on the bottom of the lid. Other methods of initiating the scanning of the user's fingerprint profile are also possible (FIG. 3). In step 825, the locking mug scans a user's fingerprint at the fingerprint scanner responsive to the initiation of the fingerprint profile scan. In step 830, the locking mug stores the fingerprint profile associated with the scanned fingerprint. In step 835, the locking mug unlocks the lid or barrier responsive to receiving the user's scanned fingerprint in subsequent scans. The locking mug unlocks the locking mug when the processor determines that the subsequent fingerprint scan matches the stored fingerprint profile. Furthermore, the locking mug assesses the user's fingerprint position to determine whether to unlock the barrier or the lid from the cup. For example, a vertically oriented finger may trigger unlocking of the barrier, and a horizontally oriented finger may trigger unlocking of the lid from the cup. In other embodiments, whether the user's finger is positioned near a top or bottom portion of the fingerprint scanner may likewise determine whether to unlock the barrier or the lid from the cup.

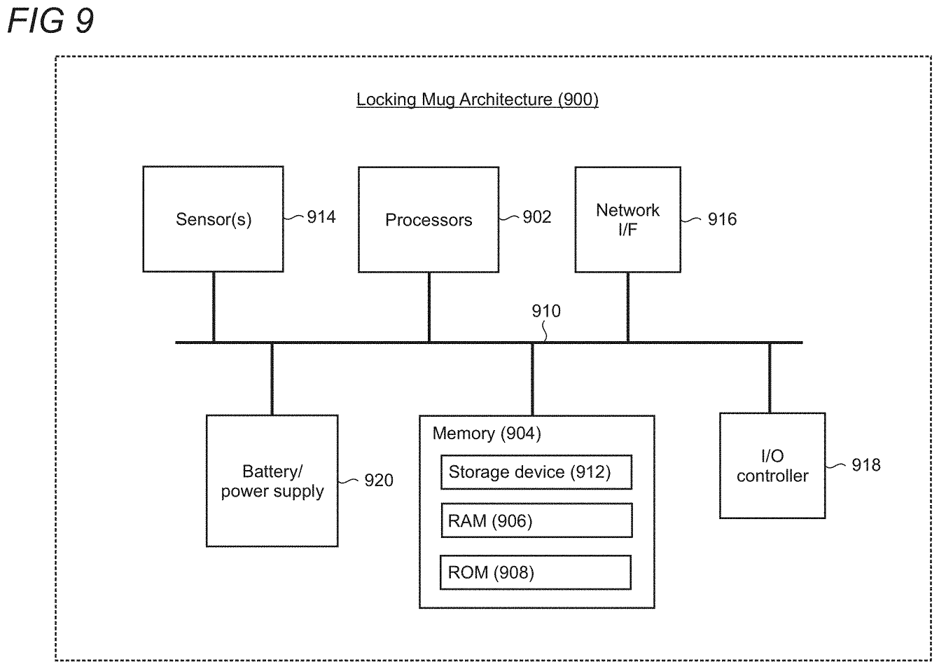

FIG. 9 shows an illustrative architecture 900 for a device, such as the locking mug 105, capable of executing the various features described herein. The architecture 900 illustrated in FIG. 9 includes one or more processors 902 (e.g., central processing unit, dedicated AI chip, graphics processing unit, etc.), a system memory 904, including RAM (random access memory) 906, ROM (read only memory) 908, and long-term storage devices 912. The system bus 910 operatively and functionally couples the components in the architecture 900. A basic input/output system containing the basic routines that help to transfer information between elements within the architecture 900, such as during startup, is typically stored in the ROM 908. The architecture 900 further includes a long-term storage device 912 for storing software code or other computer-executed code that is utilized to implement applications, the file system, and the operating system. The storage device 912 is connected to the processor 902 through a storage controller (not shown) connected to the bus 910. The storage device 912 and its associated computer-readable storage media provide non-volatile storage for the architecture 900. Although the description of computer-readable storage media contained herein refers to a long-term storage device, such as a hard disk or CD-ROM drive, it may be appreciated by those skilled in the art that computer-readable storage media can be any available storage media that can be accessed by the architecture 900, including solid stage drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 900.

According to various embodiments, the architecture 900 may operate in a networked environment using logical connections to remote computers through a network. The architecture 900 may connect to the network through a network interface unit 916 connected to the bus 910. It may be appreciated that the network interface unit 916 also may be utilized to connect to other types of networks and remote computer systems. The architecture 900 also may include an input/output controller 918 for receiving and processing input from a number of other devices, including a keyboard, mouse, touchpad, touchscreen, control devices such as buttons and switches or electronic stylus (not shown in FIG. 9). Similarly, the input/output controller 918 may provide output to a display screen, user interface, a printer, or other type of output device (also not shown in FIG. 9).

It may be appreciated that any software components described herein may, when loaded into the processor 902 and executed, transform the processor 902 and the overall architecture 900 from a general-purpose computing system into a special-purpose computing system customized to facilitate the functionality presented herein. The processor 902 may be constructed from any number of transistors or other discrete circuit elements, which may individually or collectively assume any number of states. More specifically, the processor 902 may operate as a finite-state machine, in response to executable instructions contained within the software modules disclosed herein. These computer-executable instructions may transform the processor 902 by specifying how the processor 902 transitions between states, thereby transforming the transistors or other discrete hardware elements constituting the processor 902.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 900 in order to store and execute the software components presented herein. It also may be appreciated that the architecture 900 may include other types of computing devices, including wearable devices, handheld computers, embedded computer systems, smartphones, PDAs, and other types of computing devices known to those skilled in the art. It is also contemplated that the architecture 900 may not include all of the components shown in FIG. 9, may include other components that are not explicitly shown in FIG. 9, or may utilize an architecture completely different from that shown in FIG. 9.

Various exemplary embodiments are disclosed herein. One embodiment includes a locking mug that maintains a locking state until receiving user authentication credentials, comprising: a cup having a locking mechanism; and a lid that detachably engages with the cup, wherein the lid includes: one or more processors; a fingerprint sensor; and a hardware based memory device having executable instructions which, when executed by the one or more processors, cause the locking mug to: set a fingerprint profile associated with a unique user, wherein the fingerprint profile is utilized for comparison to a received fingerprint from a scan; scan a fingerprint from a user's finger responsive to the user's finger being placed over the fingerprint sensor; compare the scanned fingerprint with the fingerprint profile; and either unlock the lid responsive to the scanned fingerprint satisfying a threshold similarity level to the fingerprint profile, or maintain the lock on the lid responsive to the scanned fingerprint failing to satisfy a threshold similarity level to the fingerprint profile.

In another example, a bottom of the lid includes an input mechanism which enables the user to configure the locking mug to set the fingerprint profile. In that example, the input mechanism on the bottom of the lid includes membrane switches which are water resistant. In another example, the executed instructions further cause the locking mug to: receive an input code at the input mechanism; verify that the input code matches a pre-set code unique to the locking mug; and enable the user to scan their finger for the fingerprint profile responsive to the input code being verified. As another example, the locking mug further comprises an indicator light positioned on a top of the lid, wherein the indicator light indicates whether the lid is in a locked or unlocked state. Another example further comprises a charging port on the lid. In that example, the charging port includes a liftable cover to protect the charging port when not in use. As another example, the locking mug further comprises: a receptacle on the cup; and a connector on the lid, in which the connector engages with the receptacle when the locking mug is locked and disconnects from the receptacle when the locking mug is unlocked. That example further comprises an actuator which causes the connector to extend when the locking mug is in the locked state and compress when the locking mug is in the unlocked state. As a further example, the executed instructions further cause the locking mug to: assess a position or orientation of the user's finger when placed on the fingerprint sensor; and based on the assessed position or orientation of the user's finger on the fingerprint sensor, determine whether to unlock a barrier on the lid to expose an opening on the lid or to unlock the lid from the cup. In that example, positions and orientations which affect which feature on the lid to unlock include a directional orientation of the user's finger or a positioning of the user's finger on the fingerprint sensor.

1. A locking mug that maintains a locking state until receiving user authentication credentials, comprising:
a cup having a locking mechanism; and
a lid that detachably engages with the cup, wherein the lid includes:
one or more processors;
a fingerprint sensor; and
a hardware based memory device having executable instructions which, when executed by the one or more processors, cause the locking mug to:
set a fingerprint profile associated with a unique user, wherein the fingerprint profile is utilized for comparison to a received fingerprint from a scan;
scan a fingerprint from a user's finger responsive to the user's finger being placed over the fingerprint sensor;
compare the scanned fingerprint with the fingerprint profile; and
either unlock the lid responsive to the scanned fingerprint satisfying a threshold similarity level to the fingerprint profile, or maintain the lock on the lid responsive to the scanned fingerprint failing to satisfy a threshold similarity level to the fingerprint profile.

2. The locking mug of claim 1, wherein a bottom of the lid includes an input mechanism which enables the user to configure the locking mug to set the fingerprint profile.

3. The locking mug of claim 2, wherein the input mechanism on the bottom of the lid includes membrane switches which are water resistant.

5. The locking mug of claim 3, in which the executed instructions further cause the locking mug to:
receive an input code at the input mechanism;
verify that the input code matches a pre-set code unique to the locking mug; and
enable the user to scan their finger for the fingerprint profile responsive to the input code being verified.

6. The locking mug of claim 1, further comprising an indicator light positioned on a top of the lid, wherein the indicator light indicates whether the lid is in a locked or unlocked state.

7. The locking mug of claim 1, further comprising a charging port on the lid.

8. The locking mug of claim 7, wherein the charging port includes a liftable cover to protect the charging port when not in use.

9. The locking mug of claim 1, further comprising:
a receptacle on the cup; and
a connector on the lid, in which the connector engages with the receptacle when the locking mug is locked and disconnects from the receptacle when the locking mug is unlocked.

10. The locking mug of claim 9, further comprising an actuator which causes the connector to extend when the locking mug is in the locked state, and compress when the locking mug is in the unlocked state.

11. The locking mug of claim 1, in which the executed instructions further cause the locking mug to:
assess a position or orientation of the user's finger when placed on the fingerprint sensor; and
based on the assessed position or orientation of the user's finger on the fingerprint sensor, determine whether to unlock a barrier on the lid to expose an opening on the lid or to unlock the lid from the cup.

12. The locking mug of claim 11, wherein positions and orientations which affect which feature on the lid to unlock include a directional orientation of the user's finger or a positioning of the user's finger on the fingerprint sensor.
